(19) United States
(12) Patent Application Publication
(10) Pub. No.: US 2014/0123645 A1
(43) Pub. Date: May 8, 2014

(54) PULL CONTROL APPARATUS OF SOLAR TRACKING POWER GENERATION MECHANISM

(71) Applicant: TOPPER SUN ENERGY TECHNOLOGY CO., LTD., (US)

(72) Inventor: CHIA CHING LUO, HSINCHU COUNTY (TW)

(73) Assignee: TOPPER SUN ENERGY TECHNOLOGY CO., LTD., HSINCHU COUNTY (TW)

(21) Appl. No.: 13/762,727

(22) Filed: Feb. 8, 2013

(30) Foreign Application Priority Data
Nov. 2, 2012 (TW) 101140712

(51) Int. Cl. F03G 6/00

(52) U.S. Cl. CPC F03G 6/001
USPC 60/641.8

(57) ABSTRACT

A pull control apparatus of solar tracking power generation mechanism includes a solar power generation module two-dimensionally movably disposed on a support assembly via a carrier platform. Two link assemblies are disposed between the solar power generation module and the support assembly, which intersect each other. Each link assembly is composed of a power source, a drive member drivable by the power source and two connection cables. Two drive sections are disposed on each drive member, which are synchronously operable. First ends of the two connection cables are respectively connected to the two drive sections in reverse directions. Second ends of the two connection cables are respectively connected to two opposite sections of the carrier platform corresponding to two lateral sides of the support assembly. The connection cables are prevented from slipping on the drive members during rotation.

### BACKGROUND OF THE INVENTION

1. Field of the Invention

The present invention relates generally to a pull control apparatus of solar tracking power generation mechanism. In the pull control apparatus, the link assemblies will not slip or idle during operation. Therefore, it is ensured that the rotation of the solar power generation module can be more precisely and more truly controlled.

2. Description of the Related Art

With respect to the conventional solar power generation mechanism, the solar power generation module is generally fixed in an environment (or a site), which is spacious or is likely to be exposed to sunlight. Accordingly, the solar power generation module cannot be rotated along with the shift of the sun. As a result, the power generation efficiency of such solar power generation mechanism is relatively poor.

To overcome the above problem, various improved solar tracking power generation mechanisms have been developed and published. In such solar tracking power generation mechanism, the solar power generation module is rotatable along with the shift of the sun as set. Therefore, the solar power generation module can always just face the sun to achieve optimal sunshine reception and power generation efficiency.

For example, conventional skill discloses an elastic steel cable-controlled solar tracking power generation apparatus, which is a typical solar tracking power generation mechanism. The solar tracking power generation apparatus includes a power generation module having a first corner, a second corner, a third corner and a fourth corner, a central column, a first cable winding device and a second cable winding device, a first steel cable and a second steel cable and a first elastic anchor section, a second elastic anchor section, a third elastic anchor section and a fourth elastic anchor section. The central column has a first end mounted on a fixed structure body and a second end pivotally connected with a first end and a second end of the power generation module. The first and second cable winding devices are disposed on the central column. The first steel cable has two ends connected to the first and third corners respectively and is wound on the first cable winding device. The second steel cable has two ends connected to the second and fourth corners respectively and is wound on the second cable winding device. The first to fourth elastic anchor sections are elastically mounted on the fixed structure body. The first steel cable is conducted through the first and third elastic anchor sections in a W-form. The second steel cable is conducted through the second and fourth elastic anchor sections also in a W-form. The first and second cable winding devices serve to rotationally drive the power generation module via the first and second steel cables respectively. Accordingly, the power generation module is rotatable along with the shift of the sun as set.

However, in practice, the power generation module has a considerable total weight. Therefore, when the first and second cable winding devices (rotary wheels) are rotated to wind/unwind the first and second steel cables, the steel cables are very likely to slip relative to the rotary wheels. (This is unlikely to happen in a gear and chain transmission structure. However, the cost for the gear and chain transmission structure is higher so that the economic efficiency of such gear and chain transmission structure is low). As a result, it is hard to precisely control the rotation of the power generation module. This will affect the power generation efficiency of the entire system. It is therefore tried by the applicant to provide an improved solar tracking power generation mechanism to prevent the steel cables from slipping on the cable winding devices (rotary wheels) and avoid idling of the rotary wheels. In this case, the rotation of the power generation module can be more precisely and more truly controlled.

### SUMMARY OF THE INVENTION

It is therefore a primary object of the present invention to provide a pull control apparatus of solar tracking power generation mechanism. In the pull control apparatus, the link assemblies will not slip or idle during operation. Therefore, the rotation of the solar power generation module can be more precisely controlled.

It is a further object of the present invention to provide the above pull control apparatus of solar tracking power generation mechanism, which has simplified structure and is free from any complicated control component. Therefore, the development and manufacturing cost is lowered.

To achieve the above and other objects, the pull control apparatus of solar tracking power generation mechanism of the present invention includes: a solar power generation module, which is two-dimensionally pivotally movably disposed on a support assembly via a carrier platform; a first link assembly composed of a first power source, a first drive member drivable by the first power source and two connection cables, a first drive section and a second drive section being disposed on the first drive member, the first and second drive sections being synchronously operable, first ends of the two connection cables of the first link assembly being respectively connected to the first and second drive sections in reverse directions, second ends of the two connection cables being respectively connected to two opposite sections of the carrier platform corresponding to two lateral sides of the support assembly; and a second link assembly composed of a second power source, a second drive member drivable by the second power source and two connection cables, a third drive section and a fourth drive section being disposed on the second drive member, the third and fourth drive sections being synchronously operable, first ends of the two connection cables of the second link assembly being respectively connected to the third and fourth drive sections in reverse directions, second ends of the two connection cables being respectively connected to two opposite sections of the carrier platform corresponding to the other two lateral sides of the support assembly.

In the above pull control apparatus, each connection cable is connected to an elastic adjustment assembly.

In the above pull control apparatus, the elastic adjustment assembly at least includes an elastic member fitted on the connection cable.

In the above pull control apparatus, a first end of the elastic member is connected to an external fixed article, while a second end of the elastic member is provided with a fitting member connected to a middle section of the connection cable.

In the above pull control apparatus, the fitting member is a pulley.

In the above pull control apparatus, each connection cable is connected to a turning guide member, which is fixed on an external fixed article.

In the above pull control apparatus, the first and second power sources are motors and the first and second drive members are drive wheels. The first and second drive sections are two annular grooves disposed on the first drive wheel. The two connection cables of the first link assembly are respectively wound on the annular grooves in reverse directions. The third and fourth drive sections are two annular grooves disposed on the second drive wheel. The two connection cables of the second link assembly are respectively wound on the annular grooves in reverse directions.

In the above pull control apparatus, the support assembly is at least composed of a base seat and a support column disposed on the base seat. The solar power generation module is disposed on the support column.

In the above pull control apparatus, the solar power generation module is disposed on the carrier platform.

The present invention can be best understood through the following description and accompanying drawings, wherein:

### BRIEF DESCRIPTION OF THE DRAWINGS

FIG. 1 is a perspective view of a first embodiment of the present invention;

FIG. 2 is a perspective view showing the first and second drive assemblies and relevant parts of the first embodiment of the present invention;

FIG. 3 is a side view of the first embodiment of the present invention, showing the operation thereof; and

FIG. 4 is a perspective view showing the first and second drive assemblies and relevant parts of a second embodiment of the present invention.

### DETAILED DESCRIPTION OF THE PREFERRED EMBODIMENTS

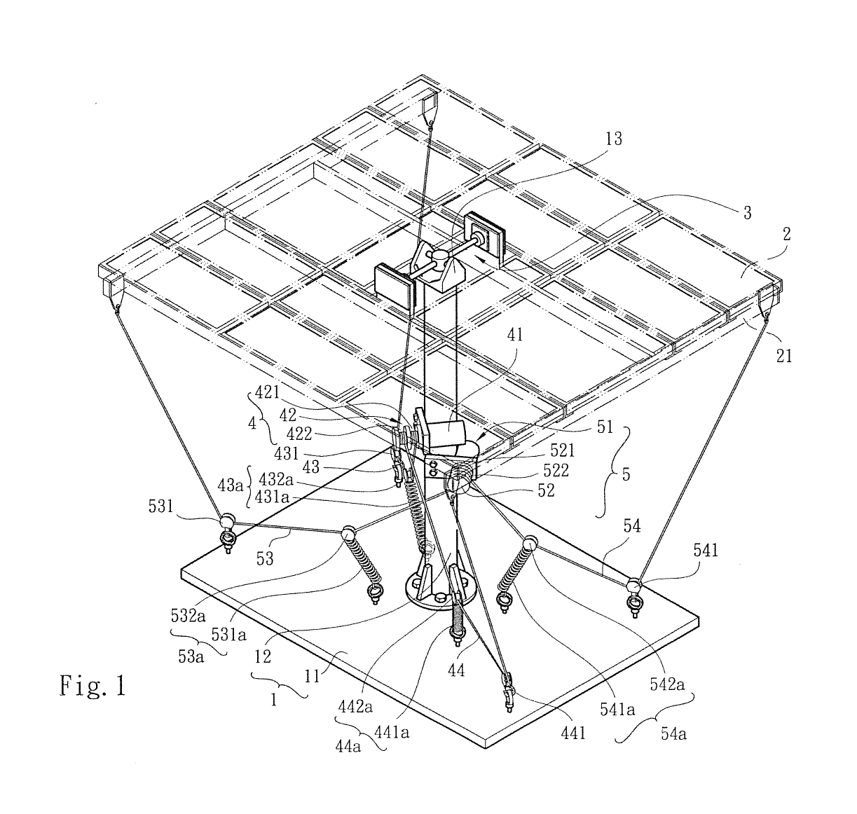

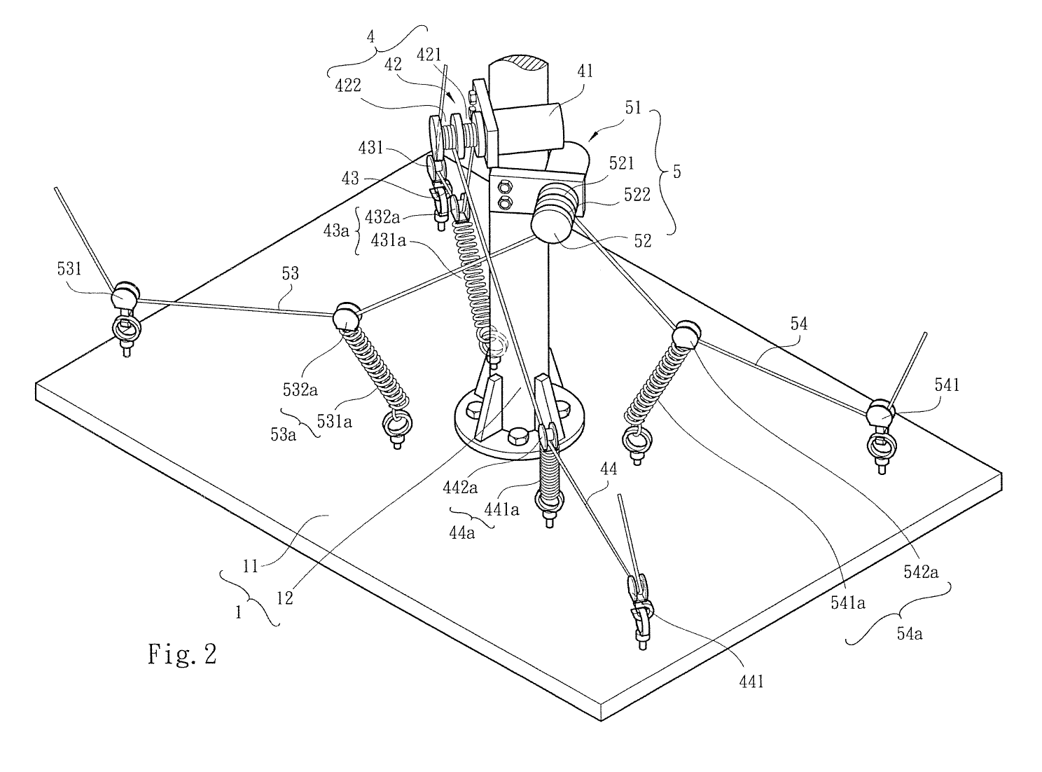

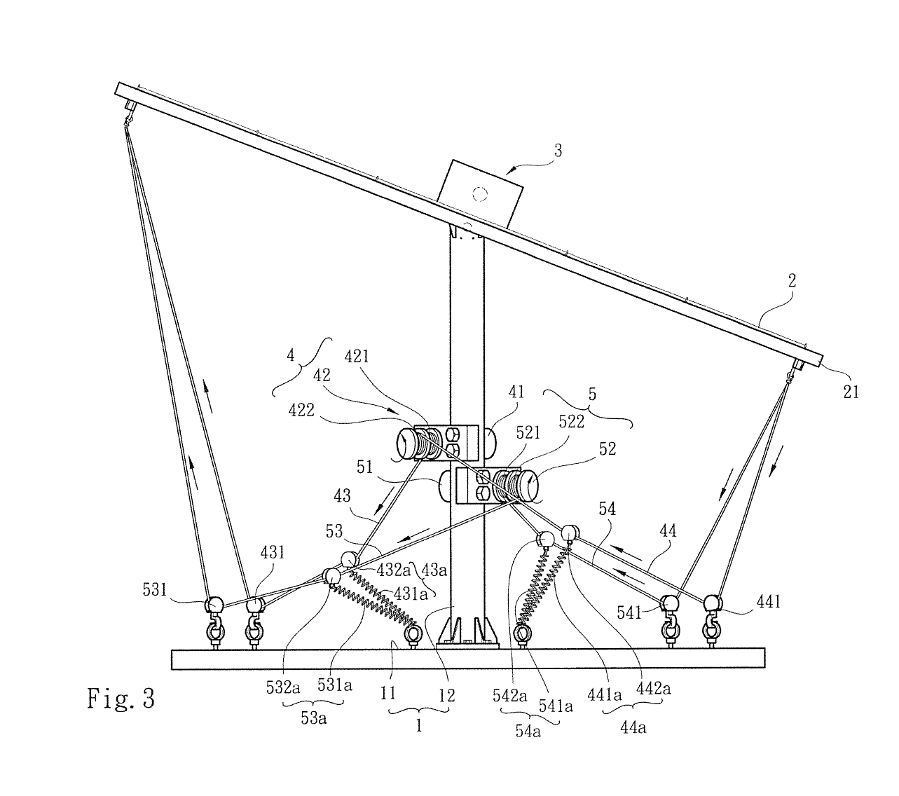

Please refer to FIGS. 1 to 3. According to a first embodiment, the present invention includes a solar power generation module 2, a first link assembly 4 and a second link assembly 5. The solar power generation module 2 is mounted on a carrier platform 21, which is disposed on a support assembly 1. The support assembly 1 is composed of a base seat 11, a support column 12 disposed on the base seat 11 and a support seat 13 disposed on the support column 12. The carrier platform 21 is two-dimensionally pivotally movably disposed on the support seat 13 via a pivot assembly 3.

The first link assembly 4 is composed of a first power source 41, a first drive member 42 drivable by the first power source 41 and two connection cables 43, 44. A first drive section 421 and a second drive section 422 are disposed on the first drive member 42. The first and second drive sections 421, 422 are synchronously operable. In this embodiment, the first power source 41 is a motor and the first drive member 42 is a drive wheel disposed on an output shaft of the motor. The first and second drive sections 421, 422 are two adjacent annular grooves disposed on the drive wheel. First ends of the two connection cables 43, 44 are respectively wound on the first and second drive sections 421, 422 (annular grooves) in reverse directions. Middle sections of the two connection cables 43, 44 are respectively conducted through two turning guide members 431, 441, (which can be pulleys connected to the base seat 11). Then second ends of the two connection cables 43, 44 are respectively connected to two opposite corners of the carrier platform 21 corresponding to two lateral sides of the support assembly 1. In practice, the middle sections of the two connection cables 43, 44 can be further respectively conducted through two elastic adjustment assemblies 43a, 44a. The elastic adjustment assemblies 43a, 44a serve to apply elastic pull force to the middle sections of the two connection cables 43, 44 so as to tension the two connection cables 43, 44 to a certain extent.

The second link assembly 5 is composed of a second power source 51, a second drive member 52 drivable by the second power source 51 and two connection cables 53, 54. A third drive section 521 and a fourth drive section 522 are disposed on the second drive member 52. The third and fourth drive sections 521, 522 are synchronously operable. In this embodiment, the second power source 51 is a motor and the second drive member 52 is a drive wheel disposed on an output shaft of the motor. The third and fourth drive sections 521, 522 are two adjacent annular grooves disposed on the drive wheel. First ends of the two connection cables 53, 54 are respectively wound on the third and fourth drive sections 521, 522 (annular grooves) in reverse directions. Middle sections of the two connection cables 53, 54 are respectively conducted through two turning guide members 531, 541, (which can be pulleys connected to the base seat 11). Then second ends of the two connection cables 53, 54 are respectively connected to two opposite corners of the carrier platform 21 corresponding to two lateral sides of the support assembly 1. In practice, the middle sections of the two connection cables 53, 54 can be further respectively conducted through two elastic adjustment assemblies 53a, 54a. The elastic adjustment assemblies 53a, 54a serve to apply elastic pull force to the middle sections of the two connection cables 53, 54 so as to tension the two connection cables 53, 54 to a certain extent.

In the first embodiment of the present invention, the elastic adjustment assemblies 43a, 44a, 53a, 54a have identical structures. Each of the elastic adjustment assemblies includes an elastic member 431a, 441a, 531a, 541a, (which can be a spring). A fitting section 432a, 442a, 532a, 542a, (which can be a pulley), is disposed at a first end of the elastic member 431a, 441a, 531a, 541a. The connection cable 43, 44, 53, 54 can be conducted through the fitting section 432a, 442a, 532a, 542a. A second end of the elastic member 431a, 441a, 531a, 541a is connected to the base seat 11. The elastic member 431a, 441a, 531a, 541a serves to elastically pull the connection cable 43, 44, 53, 54 to keep the connection cable in a properly tensioned state.

In use, the first power source 41 of the first link assembly 4 drives the first drive member 42 to rotate. As aforesaid, the two connection cables 43, 44 are respectively wound on the first and second drive sections 421, 422 (annular grooves). Therefore, in the case that the first drive section 421 forward drives the connection cable 43 to wind up the same, then the second drive section 422 simultaneously unwinds the connection cable 44. Accordingly, the two connection cables 43, 44 are synchronously extended in the same direction. Similarly, in the case that the first drive section 421 backward unwinds the connection cable 43, then the second drive section 422 forward winds up the connection cable 44. Accordingly, the first drive member 42 can drive the two connection cables 43, 44 to extend in the same direction. Moreover, the two connection cables 43, 44 are prevented from slipping on the first drive member 42 during rotation. Therefore, it is ensured that the operation is accurately performed. The second link assembly 5 is operated in the same manner. Accordingly, the solar power generation module 2 (the carrier platform 21) can be stably tilted in a predetermined direction.

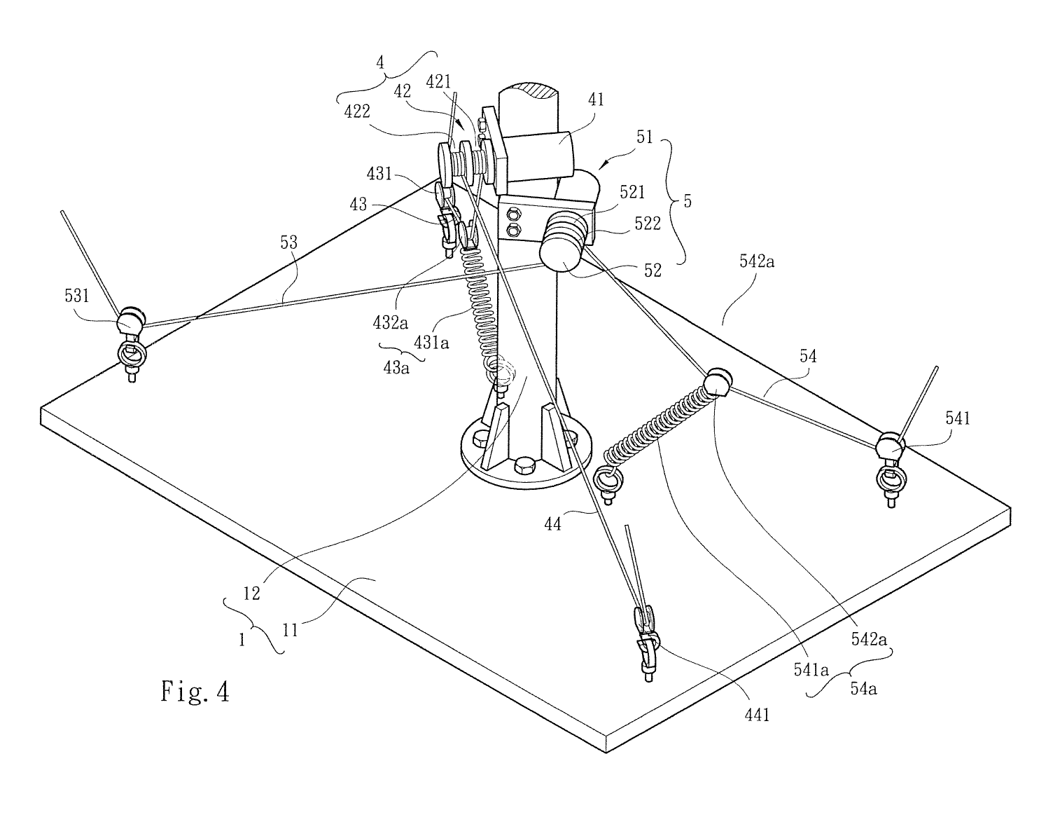

Please now refer to FIG. 4, which shows a second embodiment of the present invention. The second embodiment is substantially identical to the first embodiment in structure. In the first embodiment, the extending direction of the connection cables 43, 44 intersects the extending direction of the connection cables 53, 54. (It is shown in the drawings that the connection cables 44, 53 intersect each other, while the connection cables 43, 54 do not intersect each other). The second embodiment is simply different from the first embodiment in that the intersecting connection cables 44, 53 are not provided with any elastic adjustment assembly so as to avoid touch or interference of the intersecting connection cables 44, 53 during operation due to deflection. However, the middle sections of the connection cables 43, 54 that do not intersect each other are still conducted through two elastic adjustment assemblies 43a, 54a identical to those of the first embodiment. The other parts of the second embodiment are identical to those of the first embodiment.

In conclusion, the pull control apparatus of solar tracking power generation mechanism of the present invention will not slip or idle during operation so that it is ensured that the rotation is precisely controlled.

The above embodiments are only used to illustrate the present invention, not intended to limit the scope thereof. Many modifications of the above embodiments can be made without departing from the spirit of the present invention.

What is claimed is:

1. A pull control apparatus of solar tracking power generation mechanism, comprising:
a solar power generation module, which is two-dimensionally pivotally movably disposed on a support assembly via a carrier platform; and
a first link assembly and a second link assembly, at least one of the first and second link assemblies being composed of a power source, a drive member drivable by the power source and two connection cables, two drive sections being disposed on the drive member, the two drive sections being synchronously operable, first ends of the two connection cables of the drive member being respectively connected to the two drive sections in reverse directions, second ends of the two connection cables being respectively connected to two opposite sections of the carrier platform corresponding to two lateral sides of the support assembly.

2. The pull control apparatus of solar tracking power generation mechanism as claimed in claim 1, wherein the first link assembly is at least composed of a first power source, a first drive member drivable by the first power source and two connection cables, a first drive section and a second drive section being disposed on the first drive member, the first and second drive sections being synchronously operable, first ends of the two connection cables of the first drive member being respectively connected to the first and second drive sections in reverse directions, second ends of the two connection cables being respectively connected to two opposite sections of the carrier platform corresponding to two lateral sides of the support assembly, the second link assembly being at least composed of a second power source, a second drive member drivable by the second power source and two connection cables, a third drive section and a fourth drive section being disposed on the second drive member, the third and fourth drive sections being synchronously operable, first ends of the two connection cables of the second drive member being respectively connected to the third and fourth drive sections in reverse directions, second ends of the two connection cables being respectively connected to two opposite sections of the carrier platform corresponding to the other two lateral sides of the support assembly.

3. The pull control apparatus of solar tracking power generation mechanism as claimed in claim 1, wherein at least some of the connection cables are respectively connected to elastic adjustment assemblies.

4. The pull control apparatus of solar tracking power generation mechanism as claimed in claim 1, wherein each connection cable is connected to an elastic adjustment assembly.

5. The pull control apparatus of solar tracking power generation mechanism as claimed in claim 3, wherein the elastic adjustment assembly includes an elastic member fitted on the connection cable.

6. The pull control apparatus of solar tracking power generation mechanism as claimed in claim 4, wherein the elastic adjustment assembly includes an elastic member fitted on the connection cable.

7. The pull control apparatus of solar tracking power generation mechanism as claimed in claim 5, wherein a first end of the elastic member is connected to an external fixed article, while a second end of the elastic member is provided with a fitting member connected to a middle section of the connection cable.

8. The pull control apparatus of solar tracking power generation mechanism as claimed in claim 6, wherein a first end of the elastic member is connected to an external fixed article, while a second end of the elastic member is provided with a fitting member connected to a middle section of the connection cable.

9. The pull control apparatus of solar tracking power generation mechanism as claimed in claim 7, wherein the fitting member is a pulley.

10. The pull control apparatus of solar tracking power generation mechanism as claimed in claim 8, wherein the fitting member is a pulley.

11. The pull control apparatus of solar tracking power generation mechanism as claimed in claim 2, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

12. The pull control apparatus of solar tracking power generation mechanism as claimed in claim 3, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

13. The pull control apparatus of solar tracking power generation mechanism as claimed in claim 4, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

14. The pull control apparatus of solar tracking power generation mechanism as claimed in claim 5, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

15. The pull control apparatus of solar tracking power generation mechanism as claimed in claim 6, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

16. The pull control apparatus of solar tracking power generation mechanism as claimed in claim 7, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

17. The pull control apparatus of solar tracking power generation mechanism as claimed in claim 8, wherein the first and second power sources are motors and the first and second drive members are drive wheels, the first and second drive sections being two annular grooves disposed on the first drive wheel, the two connection cables of the first link assembly being respectively wound on the annular grooves in reverse directions, the third and fourth drive sections being two annular grooves disposed on the second drive wheel, the two connection cables of the second link assembly being respectively wound on the annular grooves in reverse directions.

18. The pull control apparatus of solar tracking power generation mechanism as claimed in claim 2, wherein each connection cable is connected to a turning guide member, which is connected to an external fixed article.

19. The pull control apparatus of solar tracking power generation mechanism as claimed in claim 3, wherein each connection cable is connected to a turning guide member, which is connected to an external fixed article.

20. The pull control apparatus of solar tracking power generation mechanism as claimed in claim 4, wherein each connection cable is connected to a turning guide member, which is connected to an external fixed article.

21. The pull control apparatus of solar tracking power generation mechanism as claimed in claim 5, wherein each connection cable is connected to a turning guide member, which is connected to an external fixed article.

22. The pull control apparatus of solar tracking power generation mechanism as claimed in claim 6, wherein each connection cable is connected to a turning guide member, which is connected to an external fixed article.

23. The pull control apparatus of solar tracking power generation mechanism as claimed in claim 7, wherein each connection cable is connected to a turning guide member, which is connected to an external fixed article.

24. The pull control apparatus of solar tracking power generation mechanism as claimed in claim 11, wherein each connection cable is connected to a turning guide member, which is connected to an external fixed article.

25. The pull control apparatus of solar tracking power generation mechanism as claimed in claim 12, wherein each connection cable is connected to a turning guide member, which is connected to an external fixed article.

26. The pull control apparatus of solar tracking power generation mechanism as claimed in claim 13, wherein each connection cable is connected to a turning guide member, which is connected to an external fixed article.

27. The pull control apparatus of solar tracking power generation mechanism as claimed in claim 14, wherein each connection cable is connected to a turning guide member, which is connected to an external fixed article.

28. The pull control apparatus of solar tracking power generation mechanism as claimed in claim 15, wherein each connection cable is connected to a turning guide member, which is connected to an external fixed article.

29. The pull control apparatus of solar tracking power generation mechanism as claimed in claim 16, wherein each connection cable is connected to a turning guide member, which is connected to an external fixed article.

30. The pull control apparatus of solar tracking power generation mechanism as claimed in claim 18, wherein the turning guide member is a pulley.

31. The pull control apparatus of solar tracking power generation mechanism as claimed in claim 19, wherein the turning guide member is a pulley.

32. The pull control apparatus of solar tracking power generation mechanism as claimed in claim 20, wherein the turning guide member is a pulley.

33. The pull control apparatus of solar tracking power generation mechanism as claimed in claim 2, wherein the support assembly is at least composed of a base seat and a support column disposed on the base seat, the solar power generation module being disposed on the support column.

34. The pull control apparatus of solar tracking power generation mechanism as claimed in claim 3, wherein the support assembly is at least composed of a base seat and a support column disposed on the base seat, the solar power generation module being disposed on the support column.

35. The pull control apparatus of solar tracking power generation mechanism as claimed in claim 4, wherein the support assembly is at least composed of a base seat and a support column disposed on the base seat, the solar power generation module being disposed on the support column.

36. The pull control apparatus of solar tracking power generation mechanism as claimed in claim 5, wherein the support assembly is at least composed of a base seat and a support column disposed on the base seat, the solar power generation module being disposed on the support column.

37. The pull control apparatus of solar tracking power generation mechanism as claimed in claim 6, wherein the support assembly is at least composed of a base seat and a support column disposed on the base seat, the solar power generation module being disposed on the support column.

38. The pull control apparatus of solar tracking power generation mechanism as claimed in claim 7, wherein the support assembly is at least composed of a base seat and a support column disposed on the base seat, the solar power generation module being disposed on the support column.

39. The pull control apparatus of solar tracking power generation mechanism as claimed in claim 11, wherein the support assembly is at least composed of a base seat and a support column disposed on the base seat, the solar power generation module being disposed on the support column.

40. The pull control apparatus of solar tracking power generation mechanism as claimed in claim 12, wherein the support assembly is at least composed of a base seat and a support column disposed on the base seat, the solar power generation module being disposed on the support column.

41. The pull control apparatus of solar tracking power generation mechanism as claimed in claim 13, wherein the support assembly is at least composed of a base seat and a support column disposed on the base seat, the solar power generation module being disposed on the support column.

42. The pull control apparatus of solar tracking power generation mechanism as claimed in claim 14, wherein the support assembly is at least composed of a base seat and a support column disposed on the base seat, the solar power generation module being disposed on the support column.

43. The pull control apparatus of solar tracking power generation mechanism as claimed in claim 15, wherein the support assembly is at least composed of a base seat and a support column disposed on the base seat, the solar power generation module being disposed on the support column.

44. The pull control apparatus of solar tracking power generation mechanism as claimed in claim 16, wherein the support assembly is at least composed of a base seat and a support column disposed on the base seat, the solar power generation module being disposed on the support column.

45. The pull control apparatus of solar tracking power generation mechanism as claimed in claim 18, wherein the support assembly is at least composed of a base seat and a support column disposed on the base seat, the solar power generation module being disposed on the support column.

46. The pull control apparatus of solar tracking power generation mechanism as claimed in claim 19, wherein the support assembly is at least composed of a base seat and a support column disposed on the base seat, the solar power generation module being disposed on the support column.

47. The pull control apparatus of solar tracking power generation mechanism as claimed in claim 20, wherein the support assembly is at least composed of a base seat and a support column disposed on the base seat, the solar power generation module being disposed on the support column.

48. The pull control apparatus of solar tracking power generation mechanism as claimed in claim 21, wherein the support assembly is at least composed of a base seat and a support column disposed on the base seat, the solar power generation module being disposed on the support column.

49. The pull control apparatus of solar tracking power generation mechanism as claimed in claim 22, wherein the support assembly is at least composed of a base seat and a support column disposed on the base seat, the solar power generation module being disposed on the support column.

50. The pull control apparatus of solar tracking power generation mechanism as claimed in claim 23, wherein the support assembly is at least composed of a base seat and a support column disposed on the base seat, the solar power generation module being disposed on the support column.

51. The pull control apparatus of solar tracking power generation mechanism as claimed in claim 2, wherein the solar power generation module is disposed on the carrier platform.

52. The pull control apparatus of solar tracking power generation mechanism as claimed in claim 3, wherein the solar power generation module is disposed on the carrier platform.

53. The pull control apparatus of solar tracking power generation mechanism as claimed in claim 4, wherein the solar power generation module is disposed on the carrier platform.
